(19) United States
(12) Patent Application Publication
(10) Pub. No.: US 2004/0143971 A1
(43) Pub. Date: Jul. 29, 2004

(54) Self Clearing Grilling Fork

(75) Inventor: Roberto Pedro Barcala, Pembroke Pines, FL (US)

Correspondence Address: Roberto P. Barcala, 11921 SW 7th Street, Pembroke Pines, FL, 33025

(73) Assignee: Dr. Roberto Pedro Barcala, Pembroke Pines, FL (US)

(21) Appl. No.: 10/707,899

(22) Filed: Jan. 22, 2004

Related U.S. Application Data
(60) Provisional application No. 60/319,900, filed on Jan. 24, 2003.

(51) Int. Cl. B26B 1/00; B25F 3/00

(52) U.S. Cl. 30/129

(57) ABSTRACT

A self-clearing grilling fork designed so that the user can effectively remove any food on the tines using a built-in trigger assembly located in the handle. This built-in trigger assembly connects to a food removal plate on the tines of the fork. As the food removal plate slides down the tines it pushes off any food present on the tines. This design allows the user to both pierce and remove food from the fork using just one hand, negating the need for another cooking utensil or the user's finger to remove the food, and leaving the user's other hand free. Furthermore, the users hand(s) are kept far from the heat of the food and grill/cooking apparatus, minimizing the chance of acquiring burns during to the cooking process, and minimizing the chance of spreading infectious disease-causing organisms.

### BACKGROUND OF INVENTION

1. Field of the Invention

The present invention relates to a barbeque or grilling fork, and more particularly pertains to a new grilling fork for lifting food on a plurality of tines and releasing said food from said tines with the use of only one hand by pulling on a trigger assembly in the handle of the fork.

2. Description of the Prior Art

The use of barbecuing or grilling is a well known and long standing favorite method of preparing food for consumption. The process of barbecuing involves various tasks such as starting the fire, cleaning the grill, seasoning the food, and grasping and/or rearranging the food on the grill. A variety of tools have been developed to assist in these tasks.

The use of barbecue forks is known in the prior art. These tools are designed and utilized to allow the user to grasp and move food without having to touch the food with any part of his or her body. Known prior art includes U.S. Pat. No. 6,536,118, U.S. Pat. No. 5,206,998, U.S. Pat. No. 4,844,525, U.S. Pat. No. 5,896,668, U.S. Pat. No. 3,162,475, U.S. Pat. No. 4,539,751, and U.S. Pat. No. 5,518,284.

Tools such as forks are designed to grasp and rearrange food, allowing a user to do so without having to touch the food with any part of his or her body. This lessens the danger to the user of suffering a burn due to contact with the food, flame, or the hot grill or stove. The possibility of transferring infectious disease-causing organisms is also decreased as there is no contact between the user and the food.

While these utensils fulfill their relevant, specific objectives and requirements, the aforementioned patents do not disclose a new grilling fork. The standard grilling fork allows the user to grasp and rearrange food with one hand. In many cases however, food grasped and rearranged by standard forks cannot be easily dislodged and/or removed from the tines of these forks. This many times results in the user utilizing the fingers of his or her free hand to dislodge the food, negating the advantages of keeping the user's person from the hot food, flame and grill, and increasing the possibility of spreading infectious disease-causing organisms. A user will also frequently agitate or shake a fork to dislodge the food from the tines of a conventional fork, resulting in an uncontrolled release of the food which may fall onto a non desirable area, such as, for example, into the flames or on the floor. Furthermore, if a second utensil is used in the other hand to dislodge food from the fork, this hand is encumbered and cannot be used to manipulate any other object, such as, for example, a plate of food or a shaker of salt.

Therefore, the grilling fork according to the present invention departs from the standard concepts and substantially improves food handling by allowing the user to dislodge food from the tines in a controlled manner using only one hand.

### BRIEF DESCRIPTION OF DRAWINGS

A self-clearing grilling fork embodying the features of the present invention is depicted in the accompanying drawings which form a portion of this disclosure and wherein:

FIG. 1a is an overhead view of the preferred embodiment of the present invention;

FIG. 1b is a side elevation view of the preferred embodiment of the present invention;

FIG. 1c is a cutaway view of the handle section of the preferred embodiment of the present invention;

FIG. 1d is a front view of the handle section of the preferred embodiment of the present invention;

FIG. 1e is a detailed view of the plastic sleeve of the preferred embodiment of the present invention;

FIG. 2a is an overhead view of the tongs and outer shaft of the preferred embodiment of the present invention;

FIG. 2b is a frontal elevation view of the tongs of the preferred embodiment of the present invention;

FIG. 2c is a side elevation view of the tongs and outer shaft of the preferred embodiment of the present invention;

FIG. 2d is a detailed overhead view of the plastic sleeve and the tongs of the preferred embodiment of the present invention;

FIG. 2e is an overhead view of the inner push rod of the preferred embodiment of the present invention;

FIG. 2f is a frontal elevation view of the food removal plate of the preferred embodiment of the present invention;

FIG. 2g is a side elevation view of the inner push rod of the preferred embodiment of the present invention;

FIG. 2h is a side elevation view of the trigger assembly of the preferred embodiment of the present invention.

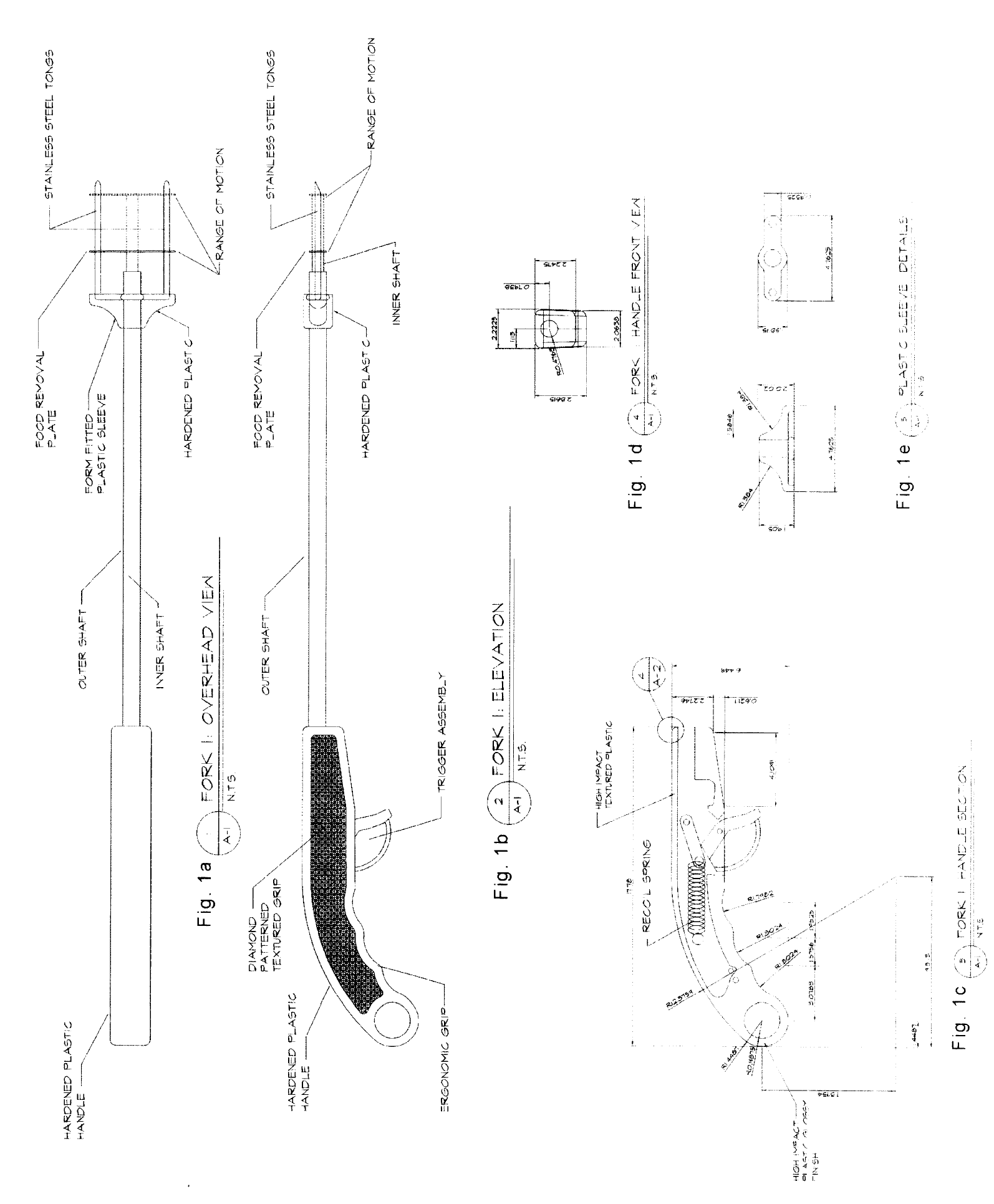

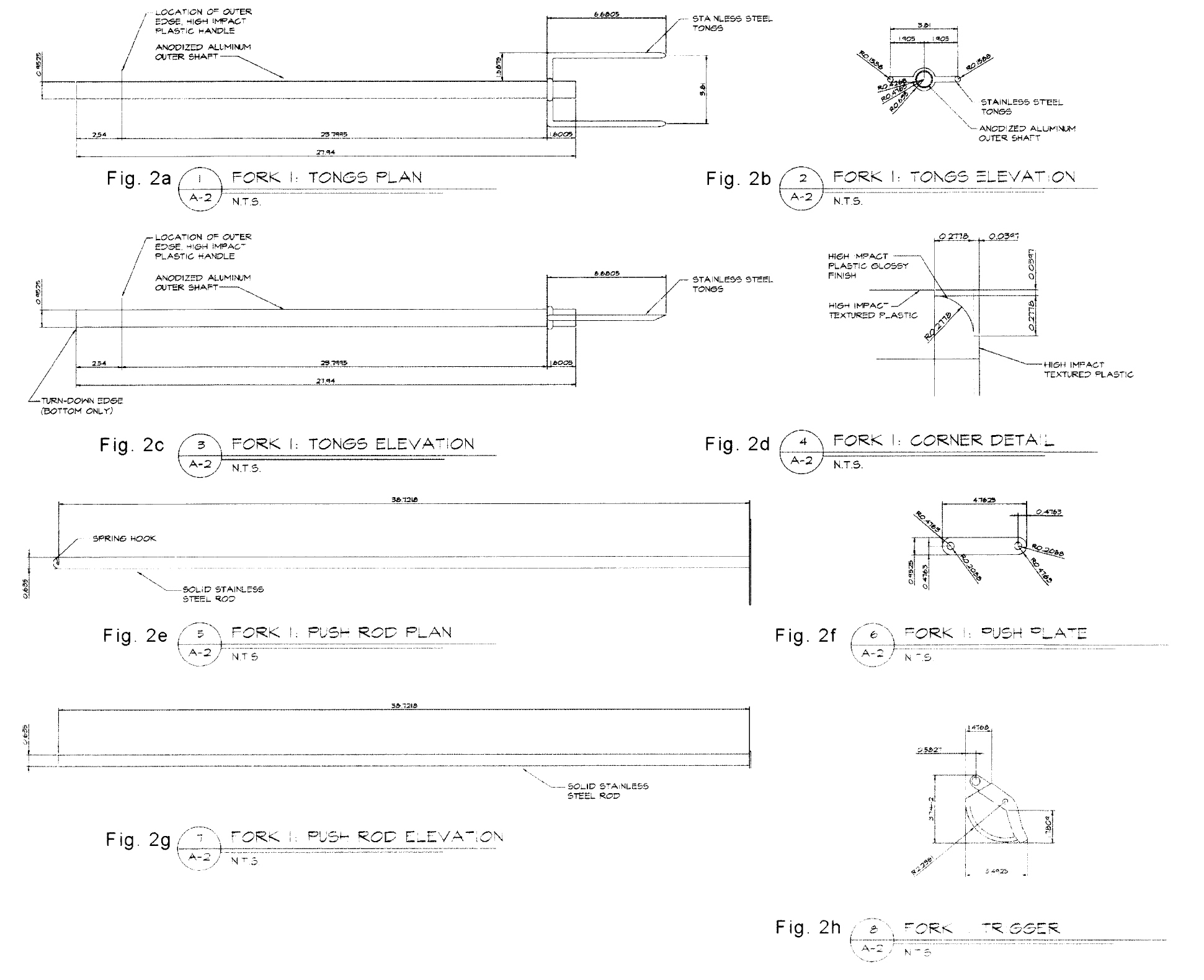

### DETAILED DESCRIPTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

It is the principal object of the present invention to provide a fork for securing, handling, and releasing food that accomplishes these actions with the use of only one hand.

Another object of this invention is to provide a fork that allows food to be released from the fork while keeping the users fingers and/or hands a safe distance from the hot food, flame and grill/cooking device to prevent the user's fingers and/or hands from being burned.

Another object of this invention is to provide a fork that allows food to be released from the fork while keeping the users fingers and/or hands a safe distance from the food and grill/cooking device to prevent the transfer and/or spread or infectious disease-causing organisms.

Another object of this invention is to provide a fork capable of securing, moving, and releasing food in a controlled manner.

Another object of this invention is to provide a fork with an easy to operate trigger assembly for releasing food.

Another object of this invention is to provide a fork having a plurality of tines and a food release plate used to push food off the tines.

Another object of this invention is to provide a fork having a trigger assembly in the handle that controls the movement of an inner shaft inside a hollow outer shaft, said inner shaft controlling the movement of the food release plate along the tines.

Another object of this invention is to provide a fork made of simple construction, easy to use, easy to clean and maintain, and inexpensive to manufacture, solving the problems and satisfies the needs existing in the art.

These and other objects of the present invention are accomplished through the use of a fork having a plurality of stainless steel tines with a food release plate positioned on and straddling the proximal end of said tines, said food release plate possessing a plurality of openings through which the tines of the fork project. The tines of the fork are connected to the distal end of a longitudinal hollow shaft by way of a form fitted sleeve of hardened plastic, while the proximal end of the hollow shaft is connected to an ergonomically shaped, textured handle of hardened plastic.

Within the hollow outer shaft resides a longitudinal inner shaft of lesser circumference. The distal end of this inner shaft is connected to the food release plate at a point midway between the plurality of openings, while the proximal end of the inner shaft extends into the handle and is connected to a trigger assembly.

The handle contains a trigger assembly inside that extends through the bottom of said handle. The user pulls the trigger, which in turn moves the connected inner shaft forward inside the hollow outer shaft, thus causing the food removal plate to slide forward along the length of the tines, removing any food that may be secured to said tines.

The present invention has been designed to be used with one hand, eliminating the necessity of removing food from the tines of the fork by means of the user's fingers, hands, or another utensil or tool, and allowing one of the user's hands to remain free. This fork provides the user a tool to secure, handle, and release food in a safe and controlled manner at the convenience of the user.

1. A self-clearing grilling fork comprising:
a handle;
a hollow, elongated cylindrical outer shaft having opposite proximal and distal ends, connected to the said handle at the proximal end;
a pair of spaced apart stainless steel tines located at the distal end of said outer shaft for the purpose of supporting food;
a form fitted sleeve of hardened plastic connecting the distal end of said outer shaft to said tines;
a food removal plate positioned on and straddling said tines, said food removal plate containing two apertures to allow said tines to slide through;
an elongated cylindrical inner shaft inside the hollow outer shaft having opposite proximal and distal ends, said proximal end extending into said handle, and said distal end extending beyond the distal end of said outer shaft and connected to said food removal plate;

2. The self-clearing grilling fork as in claim 1, wherein said handle is ergonomically shaped for user comfort, and said handle is equipped with a textured grip for a more secure grip;

3. The self-clearing grilling fork as in claim 1, wherein said handle contains a trigger assembly inside extending through the bottom of said handle, and a recoil spring inside connecting to the said trigger assembly and to the inside of said handle;

4. The self-clearing grilling fork as in claim 1, wherein said trigger assembly is connected to the proximal end of said inner shaft that extends into said handle, for the purpose of moving said inner shaft forward inside said hollow outer shaft when said trigger assembly is pulled by user;

5. The self-clearing grilling fork as in claim 1, wherein said inner shaft is connected at its distal end to said food removal plate positioned on and straddling said tines;

6. The self-clearing grilling fork as in claim 1, wherein said food removal plate is moved forwards and backwards along the length of the tines by the action of the said inner shaft it is connected to;
